(19) United States
(12) Patent Application Publication
(10) Pub. No.: US 2007/0118458 A1
(43) Pub. Date: May 24, 2007

(54) System and method for providing magnified advance payments on securities and financial security products related to the same

(76) Inventor: Juan Alberto Tadeo Albors de Lahongrais, Dorado, PR (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/549,433

(22) Filed: Oct. 13, 2006

Related U.S. Application Data
(60) Provisional application No. 60/726,720, filed on Oct. 14, 2005.

(51) Int. Cl. G06Q 40/00

(52) U.S. Cl. 705/37

(57) ABSTRACT

A forward delivery agreement supplies funds in exchange for debt service and converts debt service payments into access to higher productivity assets by providing increased flexibility. An issue and management system for long-term bonds is also disclosed. The system provides dynamic accumulation of compound interest by high-quality, high-yield assets in debt service and magnified advance reserves that enhances the investment quality of corresponding bonds. A second series of bonds (Series B) of this hybrid vehicle fund the system's payment of a magnified advance to the institutional purchaser of the Series A bonds, and the purchasers of Series B bonds securities receive interest and return of principal after the institutional investors receive periodic interest payments. Thus, when the issuer of this hybrid investment vehicle is a large-cap entity or otherwise highly stable entity, the Series A bonds satisfies institutional investors' needs for greater liquidity and stability than may be generated internally.

### CROSS REFERENCE TO RELATED APPLICATION

Priority claimed to U.S. Provisional Patent Application No. 60/726,720, filed Oct. 14, 2005, entitled “Securities with Magnified Advances” the entire contents of which are incorporated herein by reference.

### FIGURE SELECTED FOR PUBLICATION

FIG. 2

### BACKGROUND OF THE INVENTION

1. Field of the Invention

The present invention is related to an apparatus, method, and financial instrument for coordinating the sale and acquisition of securities to increase the proceeds obtained and to extend an operable term of a forward delivery agreement (FDA) by setting an interest rate of such forward delivery agreement. More particularly, the present invention is directed to a system implementing contingent acquisition and management of financial instruments to increase the proceeds obtained from sales of respective series of long-term securities by an issuer.

2. Description of the Related Art

Interest for floating rate debt securities is commonly set at an international short-term (one year or less) London Interbank Offer Rate (LIBOR) plus a constant spread: for example, LIBOR+1.25%, as in the swap noted in FIG. 1 which is discussed further below. Auction-rate debt securities (ARS), on the other hand, are long-term securities that are priced like short-term debt. The yield of ARS bonds is conventionally reset for each payment date via a Dutch auction, an auction wherein the allotment interest rate applied for all satisfied bids is equal to the marginal interest rate. Thus the increased liquidity of debt securities markets made possible through on-line auctions is particularly advantageous for ARS securities as well as certain historically illiquid bond issues, particularly corporate and other non-governmental bond issues of reduced quality. Furthermore, automation of the reset process reduces the overhead costs of the continuous management intervention required to implement the actions required by such securities.

The first on-line bond auction may have been the sale of Pittsburgh municipal bonds in 1997 by MuniAuction, Inc., now the Grant Street Group, who via inventor Harrington et al. were granted U.S. Pat. No. 6,161,099, the entire contents of which are herein incorporated by reference. The Automated Debt Auction Processing System (ADAPS) is an electronic system having a market computer system by which registered dealers participate in a market auction of federal securities in the United States. The New York Stock Exchange maintains the largest corporate bond exchange, using the Automated Bond System (ABS), which is a similarly fully automated electronic trading and information system having fully transparent schedules of bid and ask prices for registered securities.

Unfortunately, as much as 92% of the par value of all debt traded in the United States capital markets is traded by dealers in the over-the-counter (OTC) market, where the securities do not need to be registered and information may be difficult to achieve timely. In a response, individual on-line auction sites have sprung up that conduct auctions for respective municipal, state and corporate bond issuers. However, to assure transparency and guard against insider pricing, the NASD (National Association of Security Dealers) now requires all transactions to be reported immediately to their Transaction Compliance Reporting Engine (TRACE), providing transparency for these auctions, as well.

Certain types of bond vehicles, including zero-coupon bonds (zeros) and capital-appreciation (CABs) bonds are well-known. Zeros are a distinctive type of debt security that entered the marketplace in the 1980's. CABs are interest-bearing bonds that pay out interest and principal at maturity. In contrast, zeros are original issue discount (OID) securities that are sold at a discount from their face value (par), unlike CABs. These zeros have no interest rate but, like CABs, zeros produce no pay out until maturity. However, appreciation of the market value of zeros from their OID price is taxable as capital gains. Zeros have been issued by the U.S. treasury, as well as select corporations and municipalities through their respective bond agents. Municipalities also may issue “convertible zeros” which defer income paid to the purchaser until a date at which the zero is converted to an interest-bearing bond, often after eight or fifteen years for a 30-year bond, providing investors greater flexibility in tax planning, but a limited horizon for the advantage.

Asset backed securities (ABS) are high-quality, high yield bonds or notes issued by financial institutions to raise liquid working capital. This ABS paper is backed by the high-quality financial assets commonly owned by financial institutions, such as first mortgages, credit-card receivables, automobile and home-equity loans conventionally issued by financial institutions. The financial institutions also frequently offer ABS bonds through trusts set up by a special purpose corporate vehicle (SPV) that purchases those high-quality assets from the financial institution to insulate the assets from risks associated with any future bankruptcy of that financial institution, thereby further improving the credit rating of the investment quality of the ABS bonds.

In addition to the structural bankruptcy remoteness of the SPV that now owns the assets underlying these ABS bonds, their credit rating may be further enhanced internally by over-collateralization, such as that which occurs through subordination of a tranche of the bonds being issued. Tranches are broadly a piece, portion or slice of a deal or structured financing. The ABS bonds' credit rating may also be enhanced internally by over-servicing, such as that offered by “turboing” provisions. So called turboing establishes a reserve fund to reimburse the ABS trust for current-period asset loses up to the amount of the reserve fund. The net amount of interest that this reserve fund receives from underlying assets purchased by the reserve fund, after payment of expenses and amounts due to bondholders from the ABS trust, sustains the reserve fund.

Limited forms of external enhancements may be provided for ABS bonds, and include insurance, that is, surety bonds issued by a rated, regulated insurer, and also third-party/parental guarantees. These surety bonds insure timely payment to the ABS bond purchaser of the principal and interest due on those securities.

Bond guarantees are usually required to obtain the minimum investment-grade ratings of BBB/Baa, whereas surety bonds may only be available for investment-grade securities. Somewhat similar to ABS issues, third-party/parental guarantees may include letters of credit (LOC), and cash-collateral accounts (CCA) or collateral-invested amounts (CIA), each of which provide guaranty coverage up to some stated cash amount, in the form of a debt service reserve fund (DSRF) for example. CCA guarantees are provided by funds borrowed from commercial sources that are invested by the trust in the highest-rated short-term commercial paper, a one-month term for example, that funds the guaranteed amount. CIA guarantees are funded by a sale of a subordinated tranche of the securities to a given third-party, or securitization of a subordinate tranche for sale to several investors as a private placement to a qualified institutional buyer (QIB) pursuant to 26 CFR §1.144A, a transaction that is not required to be reported on the NASD's TRACE system. Thus the credit enhancement provided by CCA and CIA guarantees is not subject to change in the event that the credit rating of the insurer/guarantor is downgraded.

However, in order to assure that the issuer will realize a desirable internal rate of return, Conventional Forward Delivery Agreements (FDAs) may be used accumulate funds in the DSRF, thereby assuring timely repayment of the principal, payments made in accordance with the predetermined schedule of a sinking fund for example. Conventional Forward Delivery Agreements obligate others to deliver specific types of security on specified future dates at fixed yields for the specific purpose of optimizing the investment of a debt service reserve fund. For example, institutional bond purchasers may be required to deliver revenue-producing assets having a credit rating and fixed rate of return high enough to be acceptable to the bond issuer for use in their DSRF (such as AAA-rated and/or otherwise acceptable securities) in order to meet a specific rate of return in exchange for successive payments to the investors. FDA assets and revenue are held by the DSRF until maturity, but ownership title may remain in the institution that provides the FDA to the DSRF.

As an example useful to the present understanding, on May 8, 2004 the Commonwealth of Puerto Rico auctioned $62,000,000 in 2004B-8 bonds receiving a 3.509% fixed interest rate. These were 28-year General Obligation Bonds, the subject of legislation irrevocably pledging the good faith, credit and taxing power of the Commonwealth for prompt payment of principal and interest. The issuer's internal rate of return—the effective expense rate borne by the Commonwealth when issuing these 2004B-8 bonds, after an insurance fee of 2.796%—was 3.642%.

As shown in FIG. 1, using the financial references above as an example, the issuers' indenture terms included an Interest Rate Agreement (IRA) to hedge the variable cost of the 2004B-8 Auction Rate Securities (ARS). The IRA defines a swap that enables the Commonwealth to obtain high-quality floating-rate bonds with a defined yield: For example, AAA-rated Lehman Brothers Special Financing (LBSF) bonds at the London Interbank Offered Rate (LIBOR), which is the rate applicable to loans between money-center banks, plus a stated percent spread in exchange for the 2004B-8 securities. The 2004B-8 bonds were sold in the securities markets as U.S. tax-exempt bonds pursuant to 26 CFR § 1.103.

As discussed briefly, in FIG. 1 the bond issuer 1 above was the General Development Bank of the government of Puerto Rico 1a and the bonds were Public Improvement Refunding Bonds (PIRB) that were tax exempt in the United States. To support such action, the Puerto Rican government 1) can pledge the taxing power of the Commonwealth—e.g., that legislation was pending according to the 2004B-8 indenture—but it also 2) paid an FGIC insurance premium 30 via the US Tax Exempt market 4, and 3) provides an IRA swap agreement 32 to improve the quality rating of the 2004B-8 bonds.

Unfortunately, the related art fails to provide cash immediately for a Forward Delivery Agreement that starts to operate in the distant future, or longer applying the below-invention. The related art similarly fails to provide such an instrument in a manner that will create it's own market.

As a further difficult present in the related art, and in contrast to these Commonwealth bonds, bonds issued by Commonwealth corporations such as the Puerto Rico Electric Power Authority (PREPA), and agencies of the government of Puerto Rico, such as the Puerto Rico Public Finance Corporation (PRPFC), are at a disadvantage in the U.S. bond market, and are viewed as “foreign” corporations that are not entitled to issue tax exempt bonds under United States law.

Similarly as a further detriment, it is widely recognized that the accumulated debt owed by the United States Treasury at the present time has reduced the subsidies that it had provided to support economic development in the Puerto Rican Commonwealth in the past, as well as increasing the amount of debt the United States Treasury must sell, thus competing with other bond issuers. Additionally, there is a need for a financial solution of sufficient simplicity to allow for the components of the below-proposed invention to generate the highest benefit of a transaction via a control methodology employing the rate of return upon which it is set while retaining flexibility to allow for the transformation of the forward delivery agreement itself via, for example, Series B bonds and Series A bonds in order to magnify and advance the benefits of the transaction.

Accordingly there is a need for a financial system, method, apparatus, or instrument that provides Forward Delivery Agreements and supporting systems that are sufficiently flexibly to allow for a type of detachment to access assets with the highest productive returns. There is a need, for example for a solution to excess investments owned by surplus capital accumulation, for example, which can be converted into future funds in the distant, non-conventional time phrase where other mechanism do not reach extend.

Additionally there is a need for a security with a magnified advance that allows participants to provide investment funds through a forward delivery agreement without affecting ownership structures, such as those of financial institutions as prospective bondholders that supply capital through the proposed invention. There is an optional need for bondholders to obtain upfront resources via a unique Magnified Advance and/or a Bonds (Series B) component, in order to perform their productive functions.

It is additionally proposed that there is a need for a method of setting an interest rate for a forward delivery agreement that will ensure all related financial, legal, and regulatory requirements are met and still magnify an advance.

It is similarly proposed that an alternative and optional aspect of the present invention is for a computational system and financial agreement that allows for enhanced future annual payments that exceed a rate of return held by General Obligation Bonds.

### SUMMARY OF THE INVENTION

The present invention provides a powerful tool for aiding securities issuers, such as PRPFC and PREPA, who are stable and have substantial assets, but also have substantial fiscal impediments, to obtain lower-cost funding to the benefit of the issuers. The investors of such securities obtain a longer funding source via the forward delivery agreement that the higher stability and/or longer permanence of the resourceful but less productive issues (vis-á-vis the investors) makes possible. A Magnified Advance provided to purchasers of securities of the first security series in accordance with the present invention produces an improved short-term yield on long-term debt securities to purchasers of securities of the first security series, providing them both a stable investment and enhanced liquidity and consequently higher productivity of assets that can be obtained worldwide.

On the other hand, high-quality, high-yield securities provided to the system by purchasers of securities of the first security series in accordance with the present invention also provide purchasers of securities of the second series a higher-quality long-term investment at a lower initial cost. The present invention also advantageously increases participation in markets offering high-quality securities.

The present invention provides a system for relieving public and private fiscal impediments and fiscal distress, in particular, those presently affecting the employment and well being of United States citizens living in the Commonwealth of Puerto Rico. High-yield, high-quality (HQ) assets are received from a purchaser of securities of a first series, and periodic debt service payments are provided to that purchaser during a first period after securities of the first series are sold to that purchaser. These HQ assets are held in debt service and magnified advance reserve funds.

Sale of the securities of the first series (Series A) and second series (Series B) produces first and second principal amounts, respectively. A magnified advance reserve having a value at least equal to a current value that a continuation of the periodic payments to the purchaser of securities of the first series would have if continued through a second period following said first period. Consequently, the dynamic accumulation of interest by these high-quality, high-yield assets in these reserves enhances the investment quality of the proposed BMACs, and funds payment of a magnified advance to the purchaser of securities of the first series and other payments to purchasers of the BMAC securities.

Preferably, a purchaser of securities of the first series is a financial institution that issues high-quality securities having the having at least a given minimum fixed interest rate and credit rating.

Preferably the magnified advance is transferred during a first time period.

Preferably, the system makes periodic payments to the purchaser of securities of the second security series during a second period that begins at the end of the first period.

Preferably, the system makes periodic payments to the purchaser of securities of the first series during a second period that begins at the end of the first period.

Preferably, the HQ assets are purchased by the system in accordance with an investment agreement, and the securities of the first series securities are sold to an institutional investor after the system receives an indication that the institutional investor has executed the investment agreement.

In accordance with a preferred embodiment, the first security series is offered for purchase subject to conditions that commit a purchaser of securities of the first series of securities to provide high-quality securities having at least a given minimum yield and credit rating to the issuer. The conditions also commit the issuer to pay a magnified advance to the purchaser.

In particular embodiments the investment agreement is an FDA that obligates the institutional investor to supply HQ securities over all, or at least over an initial part of, the life of the BMAC securities on given terms. This FDA is itself an asset, proceeds from its modification, transfer, sale, funding, securitization or extinguishment providing reduced-cost risk management, in place of costly insurance, thereby assuring the integrity of these securities and conformity with the issuer's financial plan. Reliability of the issuer's financial plan is particularly important for issuers that must obtain approvals from multiple entities.

In a particular embodiment, the securities of the second series of securities are capital appreciation securities.

Preferably, the second period is the second half of the period of time before maturity of securities of the first security series.

Preferably, an FDA is required from the purchaser of said securities of said first series of securities that commits the purchaser to transfer high-quality securities having at least a given minimum fixed interest rate and credit rating, said FDA being required to be surrendered to the purchaser of securities of the first series before the maturity date of the securities of the first series in exchange for a predetermined magnified advance paid to the purchaser by the issuer.

Preferably the securities of the second series are auction rate securities (ARS).

Preferably, payments of both principal and interest from the system to purchasers of securities of the second securities series begin after payment of a magnified advance to an institutional purchaser of securities of the first series.

Preferably, consideration received from a purchaser for a sale of securities of the first series includes high-quality debt securities having an acquireror-acceptable rate of return and credit rating in accordance with the FDA supplied to the issuer by that purchaser for the securities of the first series.

Preferably securities of the second series are one of a group of types of securities including but not limited to a capital appreciation bonds, or a zero-coupon bonds, or a convertible zero-coupon bonds.

Preferably it is recognized, by the present construction, that the rate of return of forward delivery agreements that inventors agree to provide an issuer in a fair market is a very useful tool in the business process discussed herein. As discussed herein the rate of return provides substantive control of the outcome. The rate of return for instance, may be set at a level to ensure that payments from the issuer do not exceed those that the issuer would otherwise make for interest and/or debt service, on the part of the life of the bonds that the forward delivery agreement payments replace. This recognition is particularly useful as a system tool in setting a parameter to insure the integrity of the product, the integrity of the compliance, and the rational behind the same when multiple approvals are required.

### BRIEF DESCRIPTION OF THE DRAWINGS

The invention will be better understood when the detailed description of a presently preferred embodiment provided below is considered in conjunction with the drawings provided. Reference will now be made in detail to several aspects of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional indicators, such as arrows, should not be construed to limit the scope of the invention in any manner.

FIG. 1 is a schematic flow diagram of a conventional system for the auction and redemption of securities, including basic time line information, for example, for the series 2004B-8 bond issue auctioned by the Commonwealth of Puerto Rico in the year 2004.

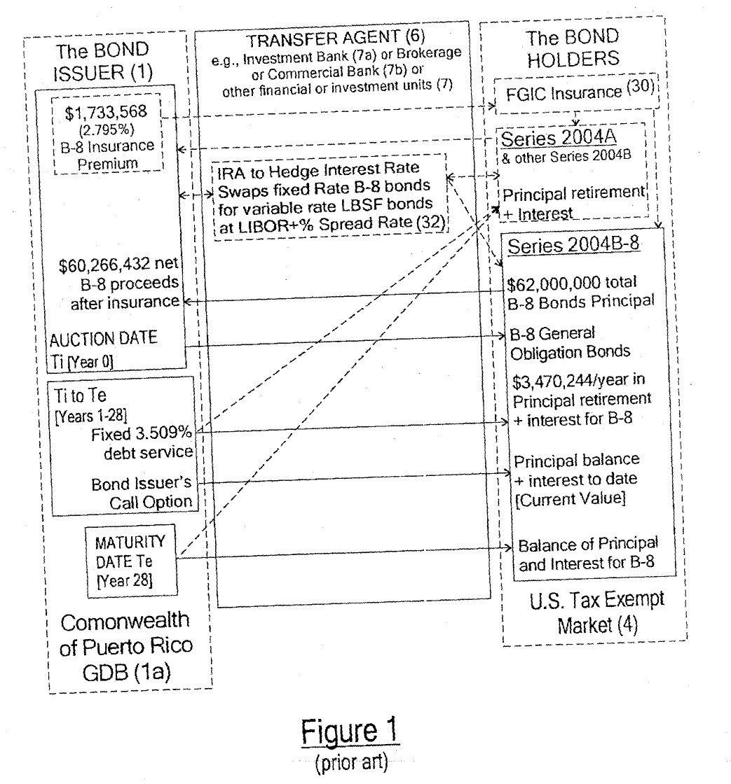

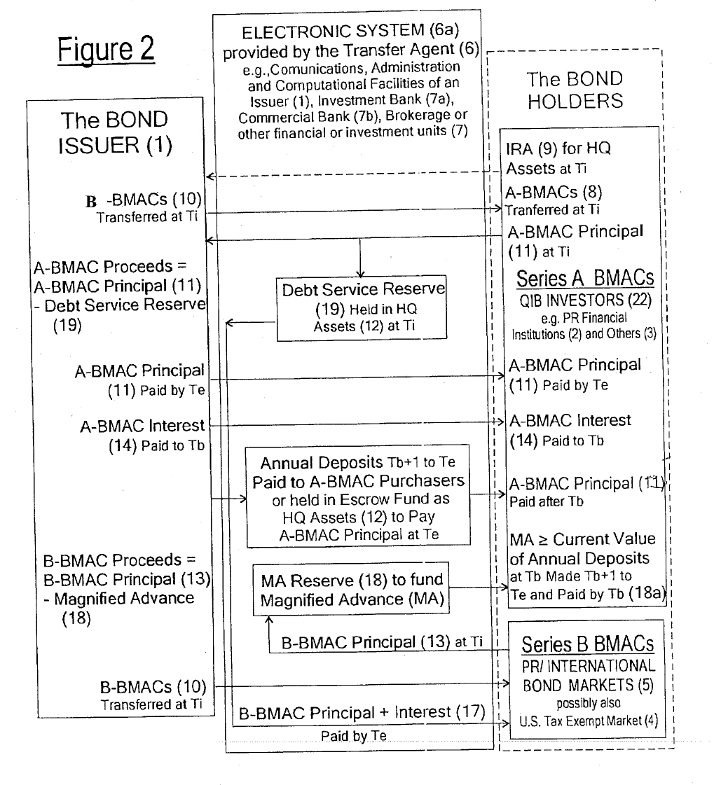

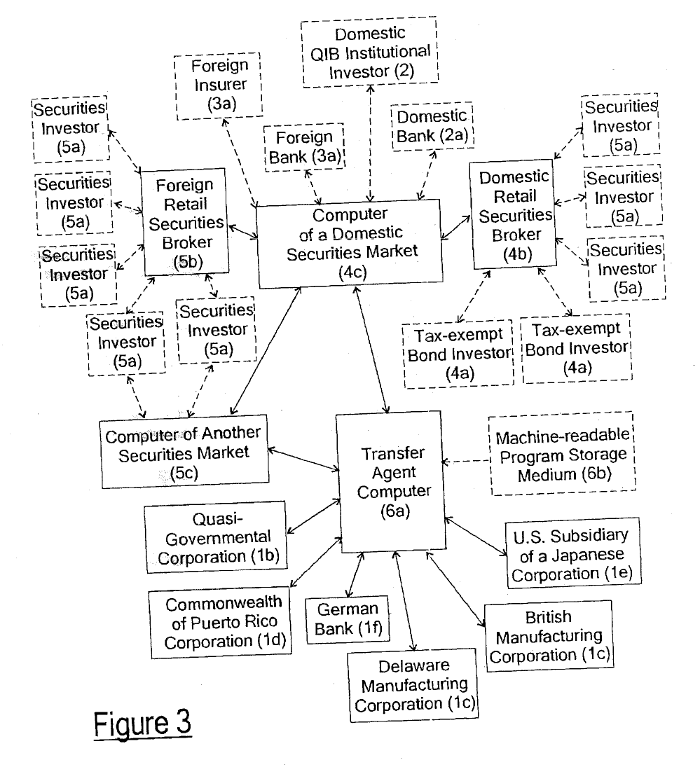

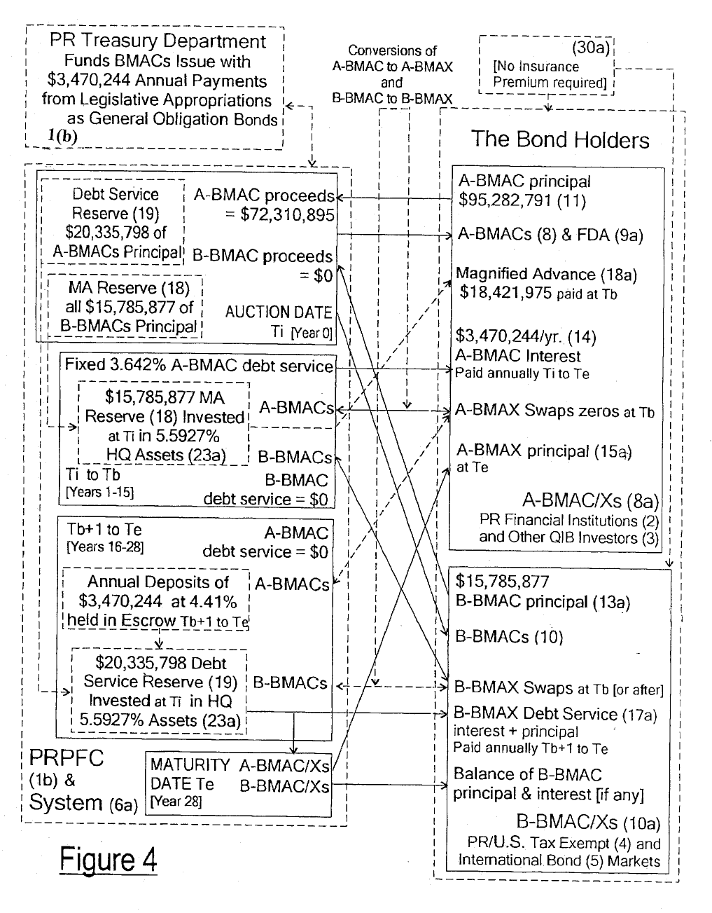

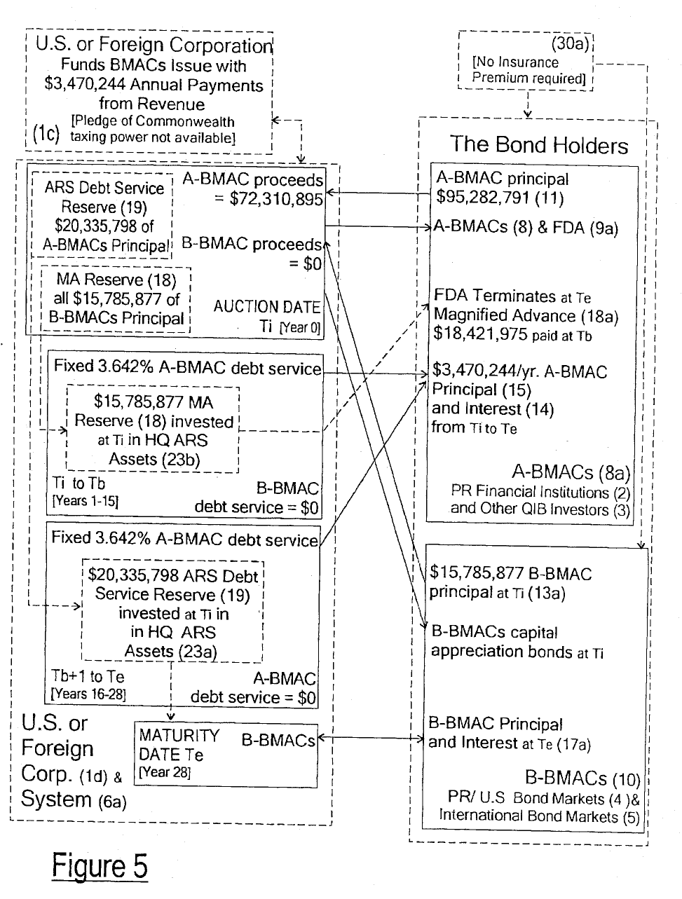

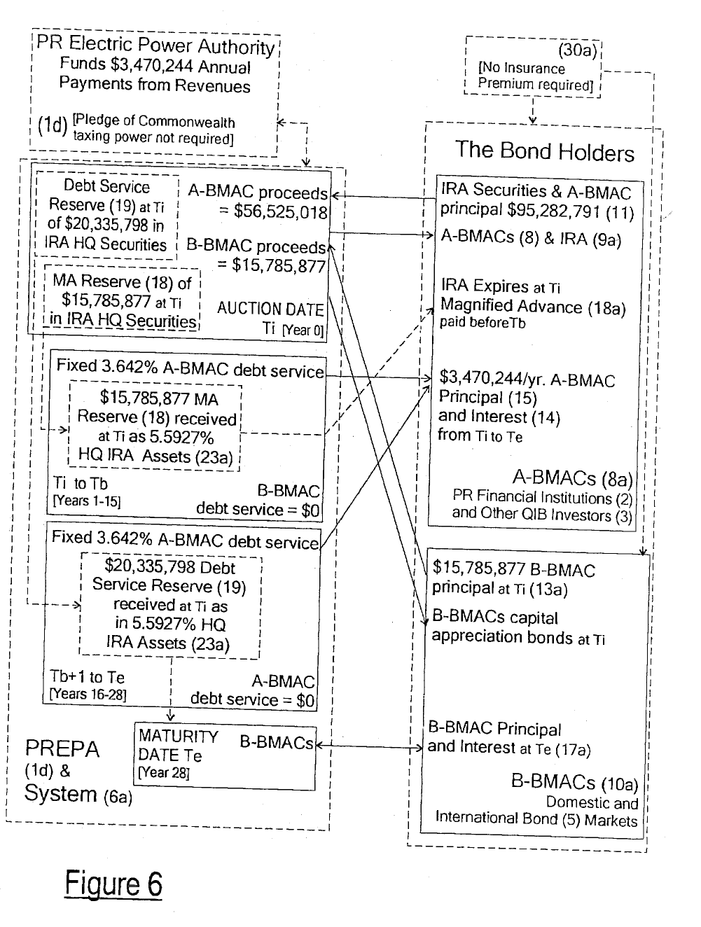

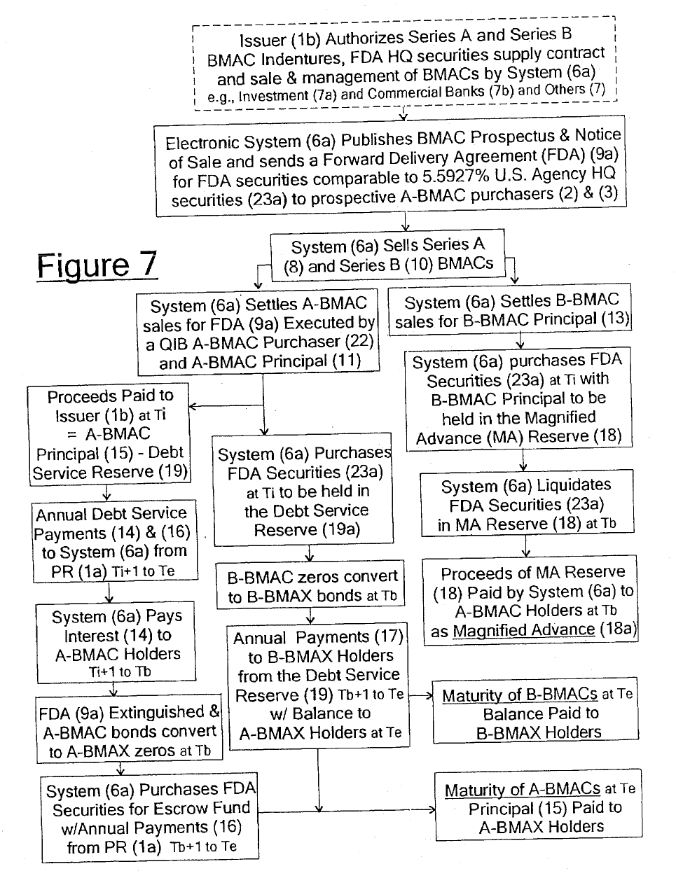

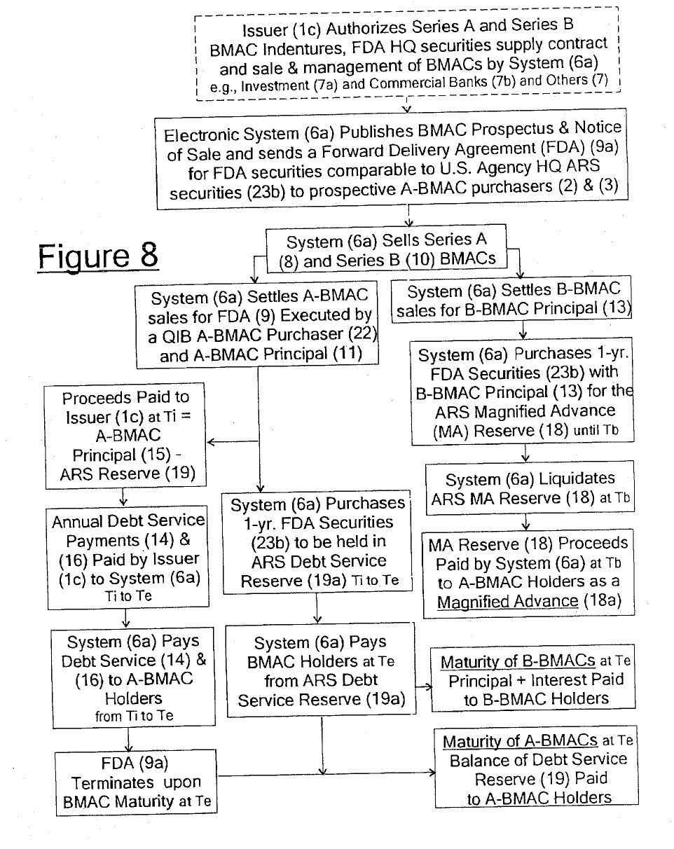

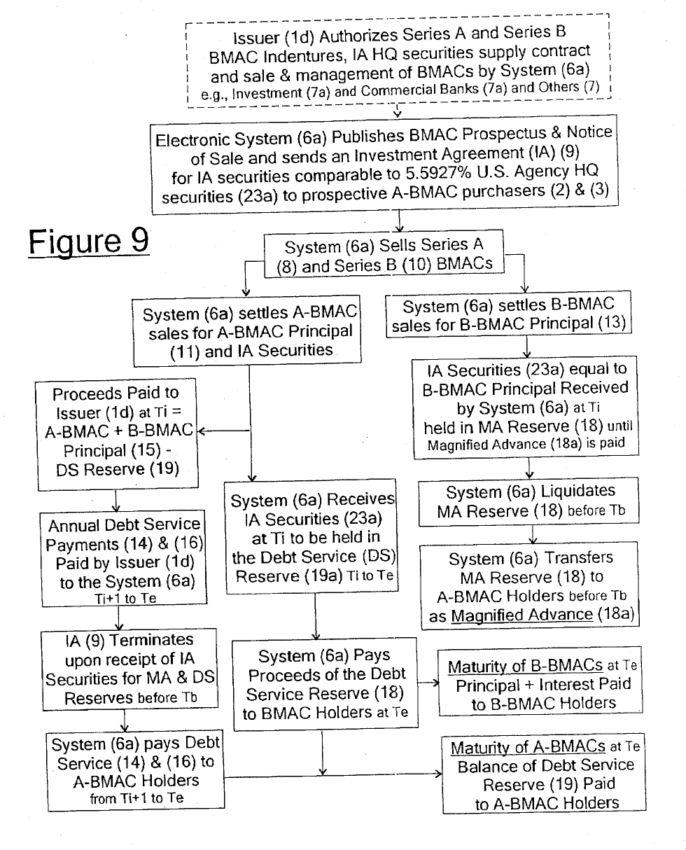

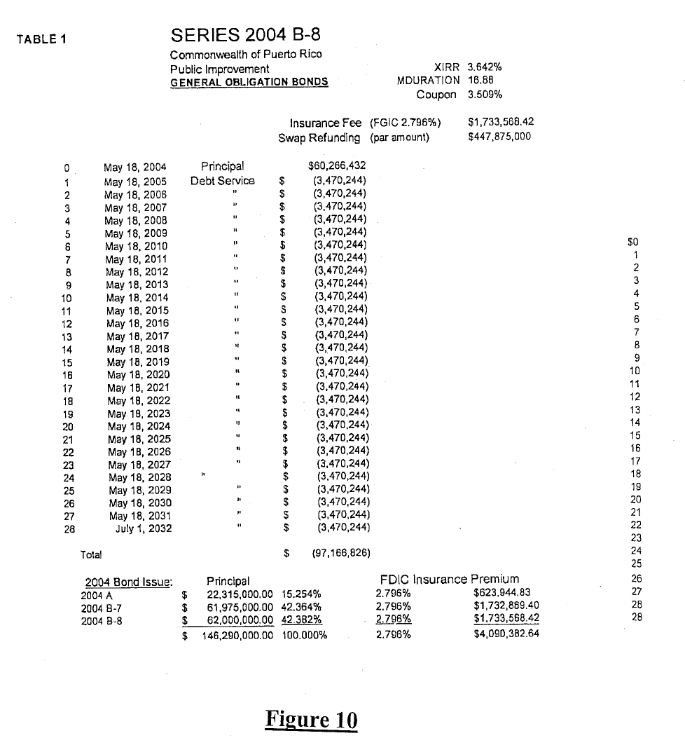

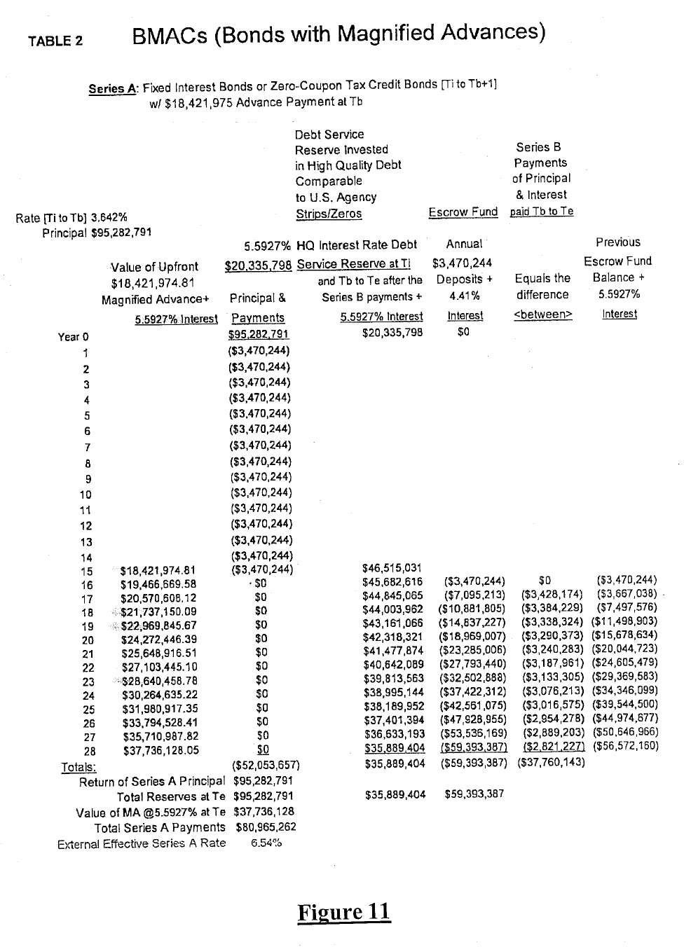

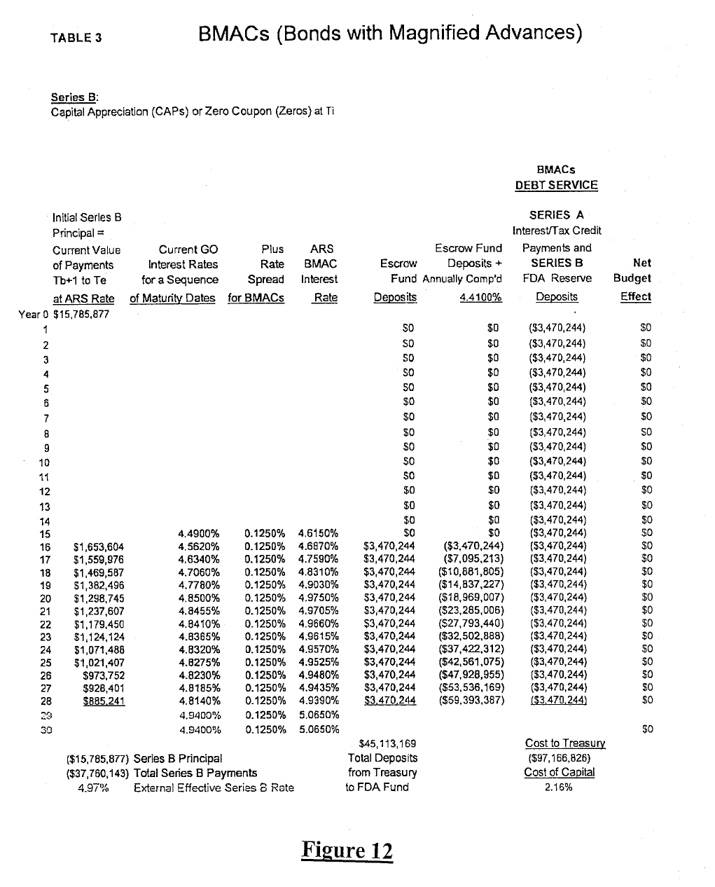

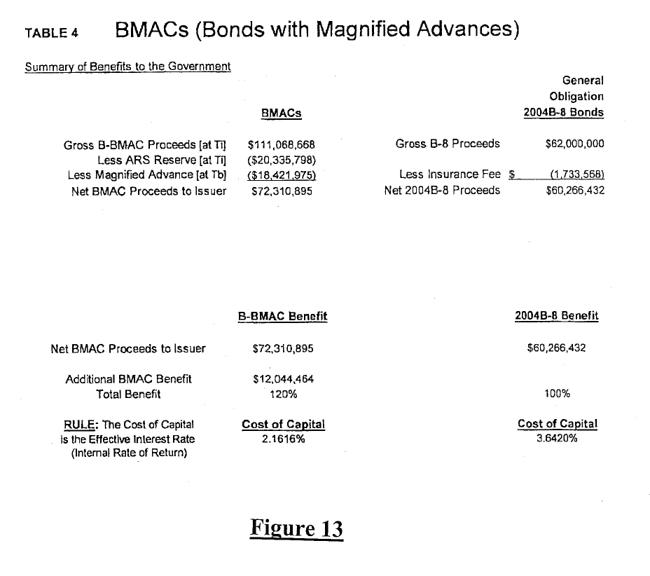

FIG. 2 is a schematic flow diagram of a system for the auction and management of securities in accordance with one aspect of the present invention.

FIG. 3 is a schematic system diagram for communication interaction involving the system shown in FIG. 2.

FIG. 4 is a schematic flow graphic showing details of the auction, conversion and redemption of a proposed bond issue for providing capital for a quasi-governmental development agency such as the Puerto Rico Public Finance Corporation in accordance with a presently preferred aspect of the invention.

FIG. 5 is a schematic graphic showing details of an auction, conversion and redemption of a proposed bond issue for providing capital for an authorized corporation (such as the Puerto Rico Electric Power Authority) in accordance with one aspect of the present invention.

FIG. 6 is a schematic time line showing details of an auction and redemption of a proposed bond issue providing capital for a U.S. or Foreign Corporation in accordance with an alternative embodiment of the invention.

FIG. 7 is a process flow chart for a preferred embodiment shown in FIG. 4.

FIG. 8 is a process flow chart for a preferred embodiment shown in FIG. 5.

FIG. 9 is a process flow chart for an alternative embodiment shown in FIG. 6.

FIG. 10—Table 1 shows payments made for the conventional tax exempt bonds of FIG. 1.

FIG. 11—Table 2 shows payments made for the A-BMAC bonds of FIGS. 4 and 7.

FIG. 12—Table 3 shows payments made for B-BMAC bonds of FIGS. 4 and 7.

FIG. 13—Table 4 compares the cost of the proceeds provided to the issuer in FIG. 1 to the advantageous result produced in accordance with present invention in FIG. 4, where the issuer has the opportunity to benefit from the higher productivity of an institutional investor's assets, while providing the institutional investor improved liquidity and stability.

In these drawings, similar structures are assigned similar reference numerals.

### DETAILED DESCRIPTION

Referring now to FIGS. 1 (earlier introduced) and 2 are transaction diagrams showing respectively a bond issuer 1, and a transfer system (6a), provided by the issuer's trust indenture agent and/or securities auction or transfer agents 6. In FIG. 1 the bond issuer 1, was introduced conventionally as the General Development Bank of the government of Puerto Rico 1a and the bonds were (for example) Public Improvement Refunding Bonds that were tax exempt in the United States.

In referring to FIG. 1, during operation of the system depicted the bond issuer 1 (the government can pledge the taxing power of the Commonwealth—that legislation was pending according to the 2004B-8 indenture—but it also 2) paid an FGIC insurance premium 30, and 3) provides an IRA swap agreement 32 to improve the quality rating of the so-issued 2004B-8 bonds.

In contrast to the conventional system in FIG. 1, in FIG. 2 because securities providing magnified advances in accordance with the invention have controllably increased effective yields and, therefore are marketable more broadly, the bond issuer 1 (in FIG. 2) is not required to be a government agency providing enhanced flexibility in the business market. Series B “BMAC” bond holders in FIG. 2 may be purchasers in the U.S. tax exempt market 4, but these bonds are more liquid as the result of the magnified advance and may also be sold in other United States and international markets and in the domestic market for high-quality, high yield securities in Puerto Rico 5. In fact, if the issuer 1 in FIG. 2 is not a government agency at all, Series B securities 10 in FIG. 2 will not be salable in the U.S. Tax Exempt market 4. The Series A securities 8 are marketed, instead, to institutional investors 2, 3 (Other QIB investors), particularly those referred to under United States securities law as Qualified Institutional Investors (QIBs).

For the convenience of the reader, investors 2, 3, that provide high-quality (HQ) securities to the system 6a are collectively referred to herein as “QIB investors” whether or not they qualify as QIBs under United States securities law. Also, for the sake of convenience, Series A and Series B securities issued and managed in accordance with the present invention are referred to herein as “A-BMACs” and “B-BMACs”, respectively, and the bond issue shown in FIG. 1 is referred to as the “2004B-8” securities their important structural and operative differences.

FIG. 3 is a schematic system diagram for an electronic bond trading system that includes a securities transfer system 6a using a stored program 6b that issues and administers at least a first and second series of securities and a number of other operative requirements known n the financial trading world. Connections between investors 4a, 5a, and brokers 4b, 5b, and between investors 5a, institutional investors 2a, 3a, brokers 4b, 5b and market computers 4c, 5c, and also between the market computers 4c, 5c and the securities transfer system 6a may be implemented in whole or in part over the internet, by using operative virtual private network connections, for example, or over a proprietary financial communications network. Securities in accordance with the present invention are advantageous for a wide range of issuers as noted above, those illustrated in FIGS. 3-6 include, without limitation:
1b) Quasi-governmental corporations, for funding investment in Puerto Rico or elsewhere;
1c) United States or foreign corporations, for funding respective investments for example;
1d) Commonwealth corporations, for funding investment in Puerto Rico or the USA for example;
1e) Foreign corporations, for funding United States or foreign investments for example;
1f) Foreign-controlled corporations, for funding United States or foreign investments for example; and
1g) International banking entities (IBE), for loans to or investments in the United States.

In the particular, but non-limiting example shown in FIG. 4, the B-BMAC bond holders are purchasers 4, 5 of convertible B-BMAC bonds 10a that are tax exempt under United States tax law, being issued by the Puerto Rico Public Finance Authority (PRPFC), a quasi-governmental development agency 1b, and paid for by legislative appropriations from the Commonwealth 1a. This borrower would ordinarily compete head-to-head in the tax-exempt market for purchasers. However, as noted herein, one advantage of the system it is stability so such competition is disadvantageous. Instead, the present invention allows the issuer to participate in the tax exempt market as a purchaser and capitalize on its stability as a borrower.

Fixed-rate Series A securities that fund the required capital contribution and a debt service reserve 19, and Series B securities that fund a prepayment of interest for the Series A securities are issued simultaneously. Series A Bonds are structured to pay interest during an initial part of their terms, from inception or the initial point in time “Ti” to an approximately mid or other point in time between the initial time Ti to the end time “Tb” on their principal amount, and to replay the principal amount at maturity which is the point in time at the end of their terms “Te”. The Series B principal is the sum of the market rate for securities in the amount of each of the interest-only payments that would have been made from Tb+1 on ward, having corresponding maturity dates from Tb+1. This amount is then invested at a higher rate in high-yield high quality (HQ) assets obtained under a forward delivery agreement 9a from A-BMAC purchasers 2, 3, at Ti; the HQ assets are held in a magnified advance reserve 18.

Since HQ assets held in the BMAC debt service reserve 19 and in MA reserve 18, combined, exceed the issuer's liability to B-BMAC holders through Te, given that Series A is subordinated to Series B, they collateralize the issuer's liability to Series B securities holders creating freedom. The HQ securities held by the debt service 19 and MA 18 reserves were provided by an FDA 9a executed by one or more A-BMAC purchasers at Ti. These A-BMAC purchasers, in effect, thereby underwrite the Series B securities so as to reduce the internal rate of return of the BMACs to the Commonwealth, while obtaining a highly stable source of funds for their high-yield financial activities.

Interest-only payments 14 on the A-BMAC securities are provided to A-BMAC purchasers 2, 3, as tax credits from Ti+1 to Tb, and return of principal is deferred to maturity 15 at Te. At Tb the A-BMACs convert to A-BMAX zeros so that, from Tb+1 to Te, the annual debt service payments from the Treasury Department of Puerto Rico (for example) are deposited to an escrow fund which increases collateralization in anticipation of the return of A-BMAC principal at Te. This debt service escrow fund is invested (for example) in market-rate securities and, in combination with the debt service reserve 19 that is invested in high-yield HQ assets obtained from A-BMAC purchasers at Ti under the FDA 18, funds the return of A-BMAC principal at Te and substantively provides increased flexibility and liquidity to access assets in a manner controlled by a determinable interest rate. As shown in the present example, but not required in every aspect of the present invention, B-BMAC holders have the option of converting from capital appreciation to interest-bearing B-BMAX securities after Tb, receiving payments of principal+interest from Tb+1 to Te.

On the other hand, in addition to receiving payment for HQ securities under the FDA 9a, the A-BMAC investors 2, 3, receive a liquidity boost from a Magnified Advance (MA) 18a at Tb, once the level of the debt service reserve 19 has risen sufficiently to maintain the necessary B-BMAC collateral position for the issuer, that is, a balance of $46,515,031 in the Debt Service Reserve is adequate to support the credit rating of the BMACs by covering both the amount set aside from the A-BMAC principal for debt service, and the B-BMAC principal. Thus, in addition to acquiring the A-BMACs as a highly stable (and hence valuable) long-term investment, the Series A bondholders, financial institutions who have access to high yield assets but have a need for external sources of stability and liquidity, are compensated for the diminished interest structure—the interest-only payments received from Ti+1 to Tb—by a near-term MA cash benefit in the form of the Magnified Advance 18a at Tb that pays a high-yield rate on the current value of the retained interest payments as calculated at Ti and extinguishes the A-BMAC purchaser's obligations under the FDA 9a.

Referring now to FIG. 5, the B-BMAC bond holders are purchasers 4, 5 of capital appreciation B-BMAC bonds issued by a major manufacturer headquartered outside the Commonwealth, in Delaware for example. This issuer has the advantage of a large capital base, which provides relative financial stability, but a lesser degree of stability. In this instance, to enhance its marketability of the magnifying process, rather than extinguishing the FDA and retaining interest payments in market rate investments, the issuer makes level annual payments from Ti+1 to Te in exchange for the A-BMAC purchaser foregoing return of capital, receiving instead the balance of the debt service reserve 19 at Te and level payments fro Ti+1 to Te. This modification provides a beneficial continuous income stream for A-BMACs purchasers, who can use that to acquire high-yield assets at will, without the constraints imposed by an FDA, which has the effect of unpegging their yield. This also reduces the issuer's overall liability. The FDA then continues to provide high-yield, 1-yr. assets or annually-reset ARS assets that fund the magnified advance 18a and the payment of principal and interest 17a on the B-BMACs upon maturity at Te.

Alternatively, in FIG. 6 for example, the B-BMAC bond holders are purchasers 4b of capital appreciation B-BMAC bonds issued by (for example) the Puerto Rico Electric Power Authority (PREPA), which is perhaps the issuer with the most stable income stream but a producer with low, fixed margins. It is also a Commonwealth public corporation 1c and therefore not entitled to issue bonds that are tax exempt in the United States. In FIG. 6, the magnified advance 18a is accelerated—paid before Tb—as soon as is consistent with the issuer's collateralization criteria—to maximize liquidity for A-BMAC holders, who again forego the return of capital at maturity in exchange for a steady stream of current payments from Tb+1 to Te that they can invest in more profitable ventures, receiving instead the balance of the debt service reserve 19 at Te. Also, to eliminate the risk inherent in any forward contract, the A-BMAC purchasers provide HQ securities to the issuer at Ti under an investment agreement (IA) 9 and that investment agreement expires as soon as those securities are delivered at Ti.

Again, the bond issue in FIG. 6 is supported by annual debt service payments from the very stable revenue stream generated by PREPA as a public utility company, a revenue stream that is highly desirable for supporting zeros or capital appreciation B-BMAC bonds that pay principal and interest at only at maturity in FIG. 6.

The Commonwealth of Puerto Rico received $60,266,432 from issuing the 2004B-8 General Obligation Bonds in Table 1 (FIG. 10), as will be discussed in more detail below. However, in addition to providing securities at a lower internal rate of return than the 2004B-8 bond issue that are marketable to a broader market segment, BMACs that are issued and managed in accordance with the present invention produce a greater capital infusion: $12,044,464 more, for the same twenty-eight level, annual debt-service payments of $3,470,244 paid by the Treasury of the Commonwealth of the Puerto Rico for the tax exempt 2004B-8. Thus the Public Finance Corporation (PRPFC), or a Commonwealth corporation that, unlike the PRPFC, cannot issue bonds that are tax exempt in the United States, receives increased working capital that does not increase the burden on the Treasury, providing beneficially no net effect on future Commonwealth budgets. Specifically, for those same twenty-eight payments, the PRPFC in FIG. 4 or the PREPA in FIG. 6 would have obtained at least $72,310,895 ($56,525,018+$15,785,877) in proceeds from their BMACs, which is, 120% of the $60,266,432 in proceeds that the tax exempt 2004B-8 General Obligation Bonds provide. As can be seen, the present invention provides substantive benefits over the known constructions.

The time line in FIG. 4 divides actions of the transfer system 6 on behalf of the issuers 1b through id of A-BMAC and B-BMAC securities in accordance with one aspect of the present invention into four time periods (as noted earlier): the Issue (Tᵢ) and Maturity (Tₑ) Dates, and the Debt Service Payment (Tᵢ₊₁ to T_{b}) and Debt Service Escrow (T_{b+1} to Tₑ) Periods. In FIGS. 5 and 6 they may be characterized, instead, as the Issue (Tᵢ) and Maturity (Tₑ) Dates, and the B-BMAC Reserve (Tᵢ₊₁ to T_{b}) and B-BMAC Payment (T_{b+1} to Tₑ) Periods. The issue and management process is set out in greater detail in the flow diagrams found in FIGS. 7-9 discussed below.

Referring again to FIG. 4 and additionally now to FIG. 7, annual fixed-interest level payments on the Series A BMAC bonds are made from Tᵢ₊₁ to T_{b}, during which time the Series B BMAC bonds are capital-appreciation bonds. A Magnified Advance 18a is paid to the institutional purchasers of A-BMAC bonds at Tb that is equal to the B-BMAC principal plus interest, here shown as 5.5927% compounded annually, that is earned by investing that B-BMAC principal in high-quality securities that were obtained at Ti through Forward Delivery Agreements (FDAs) 9a executed by one or more institutional purchasers of the A-BMAC bonds and held in a Magnified Advance reserve 18. As noted above, this Magnified Advance 18a substantially enhances the liquidity (increases freedom) of the institutional investors, enabling them to redeploy that magnified advance of capital in “better ways” including potentially risky but highly productive commercial projects, while their principal is safely funding expansion or improvement of highly stable public works.

In FIGS. 4 and 7 the system 6a also holds high-quality securities that may have been received by the system as part of the A-BMACs principal in a Debt Service Reserve 19. Alternatively, these high quality securities may have been purchased from other institutional purchasers of A-BMACs under the terms of the FDAs, using part of the A-BMACs principal. Also, in exchange for the Magnified Advance, the FDAs may permit the system to continue acquiring high-quality assets over the life of the BMAC bonds to provide rate averaging, as a protection from interest rate fluctuations, if an ARS interest rate is paid on the B-BMAC bonds, as is shown in FIGS. 5 and 8.

Referring now again to FIG. 5 and now to FIG. 8, the principal amount of the Series B BMACs that are issued is again the sum of a current value at Ti of ARS securities having the same value and the same respective maturity dates as each of the annual fixed-interest level payments on the Series A BMAC bonds that would be paid from Tb+1 to Te by the system 6a if those annual A-BMAC payments were to continue from Tb+1 to Te, as explained further below. In this example, the ARS interest rate is the rate for General Obligation bonds at the interest rates having the same respective maturities as each of the fixed payments plus (here) a 1.25% spread. At T_{b}, however, if the FDA has expired or been extinguished, the fixed-interest level payments are held in escrow by the system 6a at an estimated market rate of 4.41%, if they are not paid to A-BMAC holders.

Referring now again to FIG. 6 and now to FIG. 9, principal and interest on the Series A BMAC bonds are paid annually from Tᵢ to Tₑ with the balance due at maturity Te paid from the debt service reserve 19. Instead of receiving cash payment for the securities that are held in the MA reserve, the A-BMAC purchasers may contribute those securities and securities for the debt service reserve in kind, receiving the appreciated MA reserve 18 securities in lieu of payment of the Magnified Advance in specie. In FIGS. 6 and 9, the Investment Agreement (IA) 9 expires after the HQ securities for the debt service reserve 19 and the MA reserve 18 have been received by the system 6a and the date Tb when the Magnified Advance is paid occurs before the midpoint, as soon as possible before the fifteenth year.

It is again noted that the detailed illustration of operations of the transfer computer in the electronic system shown in FIG. 3 in accordance with the presently preferred embodiment that are summarized by the timeline shown in FIG. 4, and the process flow chart of FIG. 7, is illustrated in greater detail in the attached tables in the respective FIGS. 10-14, wherein:

FIG. 10—Table 1 shows payments made for the conventional tax exempt bonds of FIG. 1.

FIG. 11—Table 2 shows payments made for the A-BMAC bonds of FIGS. 4 and 7.

FIG. 12—Table 3 shows payments made for B-BMAC bonds of FIGS. 4 and 7.

FIG. 13—Table 4 compares the cost of the proceeds provided to the issuer in FIG. 1 to the advantageous result produced in accordance with present invention in FIG. 4, where the issuer has the opportunity to benefit from the higher productivity of an institutional investor's assets, while providing the institutional investor improved liquidity and stability.

The tables are discussed in more detail below.

Referring now specifically to FIG. 10—Table 1 is a payment spreadsheet for the Series 2004 B-8 bond issue shown in FIG. 1. The Series B-8 bonds were issued by the Commonwealth of Puerto Rico May 18, 2004, for $62,000,000 at a 3.509% fixed interest rate, and will mature Jul. 1, 2032. After adjustment for an upfront 2.796% fee for bond insurance, the internal rate of return for Series 2004B-8 is 3.642% providing $60,266,432 in proceeds at maturity. Twenty-eight level, annual debt-service payments of $3,470,244, are scheduled between Apr. 30, 2004 and the bond's Jul. 1, 2032 maturity date. They include both principal and interest. These Commonwealth of Puerto Rico Public Improvement Refunding Bonds were sold in the continental United States as tax exempt General Obligation Bonds.

Referring now directly to FIG. 13—Table 4 shows a computation of cost-benefit comparison of the 2004B-8 bond issue to a proposed issue of Series A and Series B BMACs in accordance with the presently preferred embodiment of the invention shown in FIGS. 4 and 7, as discussed above. When issued and managed in accordance with the present invention, A-BMACs and B-BMACs are marketable internationally, because of their enhanced effective external rates of return. Also, in effect, because of their use of HQ securities to fund reserves and to fund the return of A-BMAC principal, BMACs may contribute capital to the United States tax exempt bond market but are not required to compete for scarce resources in that particular market. Thus, BMACs enable the issuer to raise capital at times when the U.S. tax-exempt market is oversold, in contrast to the 2004B-8 bond issue.

Referring now directly to FIG. 11—Table 2, the initial external rate of return for the fixed rate A-BMACs interest payments is 3.642%, the internal rate seen by the issuer of the 2004B-8 securities, and that is further enhanced or “magnified” because the advance payment of interest earns 5.5927% compounded annually from Ti to Tb, truly a “Magnified” Advance” at Tb, the end of those fixed-rate payments, raising the over-all effective external rate of return to 6.54% over 28 years. Also, as shown in FIG. 13—Table 3, the B-BMAC principal is put to work at a high yield of 5.5927%, rather than the fixed 3.509% paid by the 2004B-8 bonds, with an effective external rate of return of 4.97%.

Those of skill in the art will recognize that the proceeds of the BMACs shown in FIG. 3 and FIG. 11—Table 2 and FIG. 12—Table 3, will be slightly more than $72,310,895 if the interest earned by the issuer in two additional partial periods from an April 30 offer to the May 18, 2004 settlement date, and from May 18, 2032 anniversary to the final maturity date of Jul. 1, 2032 of the B-8 bonds, partial periods occurring outside the 28-year interest-bearing period of the B-8 General Obligation Bond indenture are also included in the BMAC calculation. Thus, the BMAC model based on $3,470,244 annual payments from the Treasury for a 29-year period provides a conservative model of the cost of capital that somewhat understates the advantages of the invention.

In FIG. 11—Table 2 PRPFC has sold BMAC-type Series A Bonds with Magnified Advances (A-BMACs) for $95,282,791 in A-BMACs Principal. The buyers are institutional investors, such as Puerto Rico's financial institutions 2, other qualified institutional buyers (QIBs) who are able to privately issue securities to accredited individuals, and other investors 3 who can supply high quality, high yield securities that satisfy the requirements for HQ securities stated in the Issuer's Forward Delivery Agreement (FDA) 9a. All of these A-BMAC investors who can supply the high-yield, high-grade financial assets needed for an IRA or FDA in accordance with the invention are collectively referred to hereafter as “QIB Investors” (QIBs) 22 for the sake of convenience, whether or not they actually do qualify as such under United States securities law.

Level annual interest payments of $3,470,244, in cash or in tax-credits, during the first 15 years are shown in the second monetary column of Table 2. The $3,470,244 payments are the same annual amounts paid, and represent the same 3.642% fixed interest rate paid by the 2004B-8 Bond Issue. However, the return of A-BMAC principal, noted at the end of this column does not occur until year 28. It is not included in these A-BMAC payments. The BMAC's effective date in this example is May 18, 2004 and final maturity occurs May 18, 2032. These QIBs execute a Forward Delivery Agreement (FDA) 9a that commits them to provide HQ revenue producing assets, such as high-yield AAA-rated and/or otherwise acceptable securities in exchange for the payments PRPFC will make under the terms of the A-BMAC indenture. In the example shown in FIG. 3, the securities that these FDAs provide are equivalent in yield and investment quality to AAA 5.5927% U.S. Agency bonds. However, after the FDA is extinguished, from year 16 through year 28, the annual $3,470,244 debt service payment by the issuer accumulates in an Escrow Fund where it is invested in market securities to produce $59,393,387 toward the return of A-BMAC principal on May 18, 2032.

In addition to the Escrow Fund that receives $3,470,244 per year beginning in year 16, $20,335,798 of the A-BMAC principal was immediately invested in FDA securities at Ti that are held in the debt service reserve 19. The third monetary column of Table 2, shows the payments to B-BMAC holders from this Debt Service Reserve Fund beginning in year 16 and continuing to maturity. These payments to B-BMAC holders leave $35,889,404 in the debt service reserve 19 on May 18, 2032. This $35,889,404 is then added to the $59,393,387 that was accumulated and invested by the system 6a in the Escrow Fund, and together they pay the $95,282,791 in A-BMAC principal that is due at the A-BMAC maturity date.

The upfront disbursement provided by the Magnified Advance to holders of the Series A BMACs, may extinguish their obligation to PRPFC under the FDA comparable to AAA U.S. Agency Securities, as shown in FIG. 4 and Tables 2 and 3, or they may continue to provide HQ securities that satisfy some other requirements as to investment yield and risk that are stated in the FDA to implement floating rate interest for the Escrow Fund and the reserves 18, 19.

In FIG. 4, the Series B BMACs are 28-year capital appreciation bonds that are convertible for annual payments of principal plus interest, and the A-BMACs are fixed interest bonds that are convert to zeros at Tb. Alternatively, the B-BMACs in FIG. 4 may be convertible zeros, if the principal amount is adjusted to provide the proceeds that are required by the issuer.

Alternatively, the B-BMACs may be issued in sub-series having respective maturity dates from years 16 through 28 and corresponding interest rates for those dates, as shown in Table 3. Also, the Magnified Advance paid by the PRPFC to the holders of the A-BMACs could be followed by subsequent installments equal to the annual debt service payments that raise the total return on the A-BMACs to an acceptable level after the FDA is extinguished, transferred or sold, as in FIGS. 6 and 9. This accelerated disbursement allows A-BMAC holders themselves to invest in revenue producing assets, possibly assets more productive than securities that are acceptable under an FDA, since they are financial institutions that have the type of special investment resources available to qualified institutional buyers (QIBs). For example, investments in assets such as loans may provide a higher rate of return than the US Agencies securities that have been used as the standard for high quality securities in the computations in Table 2. However, in either case, the proposed invention serves to enhance a benefit and to attract capital into the United States.

Specifically, in FIG. 11—Table 2, from the left the first monetary column states that the principal paid for BMACs Series A bonds is $95,282,791 with a 3.642% fixed rate, either in interest or in tax credits. In Table 2, there are annual payments to the A-BMAC bond holders of $3,470,244 in each of the first 15 years, which may be paid in cash or in tax credits, with principal repaid May 18, 2032. The last three columns in Table 2, in conjunction with the columns titled “Escrow Fund” in Table 3, show that PRPFC makes annual debt service payments of $3,470,244 each, that accumulate from the year 16 through year 28 to $59,393,387 on May 18, 2032, while also paying B-BMAC bond holders the “Series B Payments” shown in the fifth monetary column in Table 2.

In Table 2, PRPFC invests or provides the Puerto Rico financial institutions and/or other investors that are BMACs Series A holders $20,335,798, for investment in securities comparable to U.S. Agency strips or zeros securities (“Agy Comp Strps/Zeros”) that pay a rate of 5.5927% annually compounded for twenty-eight years. By the end of year 15 that $20,335,798 has grown to $46,515,031.

After year 15, a Payment Account is established that operates as follows: In the sixth monetary column in Table 2, PRPFC transfers $3,470,244 worth of its own 5.5927% securities into the Payment Account in year 16. The $3,470,244 transferred to the FDA account in year 16 is the same amount as the cash or tax credit that was paid as A-BMAC interest before year 16. Those annual debt service payments made by PRPFC to the system are now being accumulated in the Escrow Fund in the fourth monetary column at 4.41%, compounded annually, to repay BMAC principal. Year 17 begins with the ending balance of year 16, which is the $3,470,244, but the securities that now are transferred are for less or $3,428,174, which is the amount needed to reach the $7,095,213 level of the Escrow Fund in shown here and in Table 3. At each step in this process, the dollar amount of the securities transferred from the debt service reserve column is sequentially lower than the FDA annual deposit, but the $59,393,387 required Escrow Fund balance at maturity is achieved. When combined with the $35,889,404 held by PRPFC in the Debt Service or ARS Reserve, this $59,393,387 provides PRPFC with the $95,282,791 principal repayment of the BMACs Series A on May 18, 2032.

In the first column from the left in FIG. 13—Table 3 shows that the B-BMACs capital appreciation and/or zero-coupon bonds are issued for $15,785,877 principal amount. The B-BMAC yield is shown on the fourth monetary column in Table 3 for each respective maturity term, beginning with the thirteen-year term from the beginning of the year 16 to the May 18, 2032 maturity date. PRPFC will pay $3,470,244 annually for years 16 through 28 (the annual FDA payments) and the amounts in the first monetary column beginning at year 16 are the respective present values of each of these $3,470,244 debt service payments at the stated applicable rates for securities having that maturity date that is listed in the fourth monetary column. Here these stated rates are the yields offered by the corresponding interest paying General Obligation Bonds (GOs) listed in monetary column two at a spread of 0.1250% between the GOs and BMACs, that is shown in monetary column three. The total of these floating rate present values of the respective $3,470,244 debt service payments made by PRPFC determines the $15,785,877 that is the amount of the magnified advance paid to A-BMACs bond holders.

The second column from the left in Table 3 shows that the total debt service on the BMACs is provided by annual payments of $3,470,244 made for years 1 through 28, which is equal to the $3,470,244 provided for annual level payments under the Public Improvement Refunding Bonds of the Commonwealth of Puerto Rico, Series 2004 B-8 (General Obligation Bonds) issued May 18, 2004 for years 1 through 28 according to the explanation of Table 1, above. In Table 3, for years 1 through 15 they are paid to A-BMAC holders in the form of interest and/or tax credit payments, and for years 16 through 28 they are paid to holders of the B-BMAC bonds. Since the in annual future payments for BMAC debt service payments are exactly the same as General Obligation Bonds, and the BMACs have no net future budget effect.

In FIG. 4 a pledge of taxing power from the Commonwealth Treasury 1a guarantying the BMACs or bonding of the BMACs by an insurer 30a may optionally be added to further increase the investment quality of the BMACs, thus possibly further decreasing the cost of borrowing in special circumstances. However, because of the advantageously increased proceeds provided by securities offered and managed by a securities system in accordance with the present invention, BMACs can provide as much or more financial capital for less total cost than comparable conventional securities that rely on insurance or the government's taxing authority, and/or the securities' tax-exempt status, such as the 2004B-8 bond issue described above.

The present invention has been described with particular reference to a presently-preferred embodiment. However, it will be apparent to one skilled in the art that modifications and variations are possible within the spirit and scope of the present invention. The invention is defined by the appended claims.

What is claimed is:

1. Computer program means for issuing and administering securities in an electronic system including a transfer agent computer adapted to be connected with at least one issuer's computer and at least one securities-market, said computer program means being adapted to cooperate with said transfer agent computer to sell and manage securities, said securities having respective maturity dates, said computer program means comprising:
means for selling a first and second series of securities, sales of said first and the second series of securities producing first and second principal amounts, respectively, securities of the first series being sold to an institutional investor;
means for receiving high-quality, high-yield assets from said institutional investor;
means for holding a first portion of said high-quality, high-yield assets corresponding to said first principal amount in a debt service reserve;
means for holding a second portion of said high-quality, high-yield assets corresponding to said second principal amount in a magnified advance means;
means for providing periodic debt service payments to said institutional investor in a first period following said sale date; and
means for transferring a magnified advance to said institutional purchaser, said magnified advance including said second proceeds, said magnified advance having a value at least equal to a current value that a continuation of said periodic payments would have if continued through a second period following said first period.

2. The computer program means of claim 1 wherein said magnified advance is transferred during said first time period.

3. The computer program means of claim 1, further comprising:
means for providing periodic debt service payments to purchasers of securities of the second series during a second period beginning at the end of said first period.

4. The computer program means of claim 1, further comprising:
means for providing periodic debt service payments to said institutional investor during a second period beginning at the end of said first period.

5. The computer program means of claim 1 further comprising:
means for receiving an indication that an investment agreement has been executed by said institutional investor, said means for selling the first and second security series being adapted to sell securities of the first series to said institutional investor after receiving said indication that said institutional investor has executed said investment agreement.

6. The computer program means of claim 5 wherein said investment agreement is extinguished when said magnified advance is transferred to said institutional purchaser.

7. The computer program means of claim 5 wherein said investment agreement is terminated before said magnified advance is transferred to said institutional purchaser.

8. An electronic system including a transfer agent computer adapted to be connected with at least one issuer's computer and with at least one securities market, said system including computer program means for issuing and administering securities in cooperation with the transfer agent computer, said securities having respective maturity dates, said computer program means comprising:
means for selling a first and second series of securities, sales of said first and the second series of securities producing first and second principal amounts, respectively, securities of the first series being sold to an institutional investor;
means for receiving high-quality, high-yield assets from said institutional investor;
means for holding a first portion of said high-quality, high-yield assets corresponding to said first principal amount in a debt service reserve;
means for holding a second portion of said high-quality, high-yield assets corresponding to said second principal amount in a magnified advance means;
means for providing periodic debt service payments to said institutional investor in a first period following said sale date; and
means for transferring a magnified advance to said institutional purchaser, said magnified advance including said second proceeds, said magnified advance having a value at least equal to a current value that a continuation of said periodic payments would have if continued through a second period following said first period.

9. The electronic system of claim 8 wherein said magnified advance is transferred during said first time period.

10. The electronic system of claim 8, further comprising:
means for providing periodic debt service payments to purchasers of securities of the second series during a second period beginning at the end of said first period.

11. The electronic system of claim 8, further comprising:
means for providing periodic debt service payments to said institutional investor during a second period beginning at the end of said first period.

12. The electronic system of claim 8 further comprising:
means for receiving an indication that an investment agreement has been executed by said institutional investor, said means for selling the first and second security series being adapted to sell securities of the first series to said institutional investor after receiving said indication that said institutional investor has executed said investment agreement.

13. The electronic system of claim 12 wherein said investment agreement is extinguished when said magnified advance is transferred to said institutional purchaser.

14. The electronic system of claim 12 wherein said investment agreement is terminated before said magnified advance is transferred to said institutional purchaser.

15. A method for administering a first and a second series of securities for an issuer, said method comprising the steps of:
selling the first and second security series, sales of the first and the second series of securities producing first and second principal amounts, respectively, securities of the first series being sold to an institutional investor;
receiving high-quality assets from the institutional investor;
holding a portion of the high-quality assets corresponding to a portion of said first principal amount in a debt service reserve;
holding a portion of the high-quality, high-yield assets corresponding to the second principal amount in a magnified advance means;
providing periodic debt service payments to said institutional investor in a first period following said sale;
and
transferring a magnified advance including said second proceeds to said institutional purchaser from the magnified advance reserve, said magnified advance having a value at least equal to a current value that a continuation of said periodic payments would have if continued through a second period following said first period.

16. The method of claim 15 wherein said method is a method of operating an electronic system including computer program means, a transfer agent computer adapted to be connected with at least one issuer's computer and with at least one securities market, said computer program means being adapted for issuing and administering securities in cooperation with the transfer agent computer.

17. The method of claim 15, further comprising the step of:
providing periodic debt service payments to purchasers of securities of the second series during a second period beginning at the end of said first period.

18. The method of claim 15, further comprising the step of:
providing periodic debt service payments to said institutional investor during a second period beginning at the end of said first period.

19. The method of claim 15, further comprising the step of:
receiving an indication that an investment agreement has been executed by said institutional investor, said means for selling the first and second security series being adapted to sell securities of the first series to said institutional investor after receiving said indication that said institutional investor has executed said investment agreement.

20. The method of claim 15, further comprising the step of:
extinguishing said investment agreement when said magnified advance is transferred to said institutional purchaser.

21. The method of claim 15, further comprising the step of:
terminating said investment agreement before said magnified advance is transferred to said institutional purchaser.
